(19) United States
(12) Patent Application Publication
(10) Pub. No.: US 2024/0270647 A1
(43) Pub. Date: Aug. 15, 2024

(54) USE OF MODIFIED CELLULOSE NANOMATERIALS IN CEMENTITIOUS COMPOSITIONS

(71) Applicants: Purdue Research Foundation, West Lafayette, IN (US); Oregon State University, Corvallis, OR (US)

(72) Inventors: Jeffrey Paul Youngblood, Crawforsville, IN (US); Jason Weiss, Corvallis, OR (US); Krishna Siva Teja Chopperla, Corvallis, OR (US); Sivakumar Ramanathan, Corvallis, OR (US)

(21) Appl. No.: 18/442,689

(22) Filed: Feb. 15, 2024

Related U.S. Application Data
(60) Provisional application No. 63/485,126, filed on Feb. 15, 2023.

(51) Int. Cl. C04B 24/38; C04B 20/10; C04B 28/04; C04B 103/10

(52) U.S. Cl. CPC C04B 24/386; C04B 20/1022; C04B 20/1037; C04B 20/1048; C04B 20/1074; C04B 28/04; C04B 2103/10

(57) ABSTRACT

Cement paste compositions including modified cellulose nanomaterials such as modified cellulose nanocrystals and modified cellulose nanofibers, are disclosed herein. In some embodiments, the cement paste compositions include from about 0.005 volume % to about 1.5 volume % modified cellulose nanomaterial.

### CROSS-REFERENCE OF RELATED APPLICATIONS

This disclosure claims priority to U.S. Provisional Application Ser. No. 63/485,126, filed Feb. 15, 2023, which is hereby incorporated by reference in its entirety.

### STATEMENT OF GOVERNMENT SUPPORT

This invention was made with government support under 18-JV-11111106-039 awarded by the USDA. The government has certain rights in the invention.

### BACKGROUND OF THE DISCLOSURE

The present disclosure relates generally to the use of cellulose nanomaterials (CNMs), including cellulose nanocrystals (CNCs) and cellulose nanofibers (CNFs), and effects of their surface structure and morphology on the properties and performance of cement paste compositions in concrete.

Cement is a well-known material and is widely employed in the preparation of mortar and concrete. Concrete, the second most used resource in the world after water, consists of fine and coarse aggregate bonded together with a binder which is composed in part from cement, also referred to herein as cement paste composition. Cement usually consists of calcium silicates and calcium aluminate oxides. Previously, carbon nanotubes (CNTs) have been employed in the cement paste composition to improve the flexural strength, and elastic modulus of the resulting cement. However, despite having benefits in controlling micro sized cracks in cement, CNTs suffer from various drawbacks, including degradation in the processing of concrete, negative impact on the pumpability of cement, issues in dispersion and mixing of fibers, and high material costs.

There is an increasing demand for cementitious binders which are stronger, durable, with quick setting rates, and an increased rate of strength gain in sectors that use cement on large scales. Cement technologists have employed various techniques to achieve desired properties and those techniques include using chemical admixtures (e.g., WRAs, air-entraining admixtures), employing fibers for reinforcements, and supplementary cement materials (e.g., fly ash, silica fumes, etc). Natural fibers have been employed in cement for years and, though they offer less effective reinforcement than their metallic counterparts, they have the advantage of being sustainable, plentiful, and economical.

It would be beneficial to use alternative materials in cement paste compositions that could provide similar advantageous properties without the drawbacks of previously used admixtures. Particularly, it would be advantageous to provide compositions that could improve the strength and resiliency, while reducing the carbon footprint of the cement paste composition.

### BRIEF DESCRIPTION OF THE DISCLOSURE

The present disclosure is generally directed to cement paste compositions, such as for use in concrete, including cellulose nanomaterials (CNMs), and particularly, cellulose nanocrystals (CNCs) and cellulose nanofibers (CNFs). In one aspect, the present disclosure is directed to a cement paste composition comprising cement, water, and from about 0.005 volume % to about 1.5 volume % modified cellulose nanomaterial.

In one aspect, the cellulose nanomaterial can be modified by ionizing the cellulose nanomaterial. In another aspect, the cellulose nanomaterial can be modified by layering silica on the outer surface of the nanomaterial. In yet another aspect, the cellulose nanomaterial can be modified by being PEGylated. In further aspects, the modified cellulose nanomaterial has been primed with tannic acid alone or in combination with the modifications above.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings, wherein:

FIG. 1 depicts the hydration effect of modifications of cellulose nanocrystals (CNCs) and cellulose nanofibers (CNFs) with carboxymethylcellulose (CMC) as analyzed in Example 1.

FIG. 2 depicts the 28-day hydration effect of modifications of CNCs with polyethyleneimine (PEI), tannic acid (TA) and TA+PEI as analyzed in Example 1.

FIGS. 3A & 3B depict the hydration effect of PEGylation on cellulose nanomaterial (CNM) surfaces as analyzed in Example 1.

FIGS. 4A & 4B depict the 28-day hydration effect of silica modification on CNM surfaces as analyzed in Example 1.

### DETAILED DESCRIPTION

Unless defined otherwise, all technical and scientific terms used herein have the same meaning as commonly understood by one of ordinary skill in the art to which the disclosure belongs.

Concrete consists of fine and coarse aggregate bonded together with cement (also referred to herein as cement paste composition). Cement usually consists of calcium silicates and calcium aluminate oxides and other components to provide improved physical and functional properties of the resulting cementitious materials. The present disclosure is generally directed to cement paste compositions including modified cellulose nanomaterials (CNMs). The modified cellulose nanomaterials, and particularly cellulose nanocrystals and nanofibers, have been found to improve the degree of reaction of the cement (as measured by non-evaporable water), while additionally providing the advantages of being sustainable and economical.

Cellulose nanomaterials (CNMs) include cellulose nanocrystals (CNCs) and cellulose nanofibers (CNFs). CNCs are rod-like particles with a fairly high aspect ratio (3-5 nm wide, 50-500 nm in length). They are mainly crystalline and are completely cellulose. They are prepared by the acid hydrolysis of wood fibers, plant fibers, cellulose nanofibers, microcrystalline cellulose, and microfibrillated cellulose. CNFs (also known was nanofibrillated cellulose (NFC) and (Cellulose Micro Fibrils (CMFs)), which are very fine fibrils of cellulose (100%), are synthesized by the mechanical or chemomechanical processing of wood fibers (WF) and pulp fibers (PF). They are high aspect ratio fibers (4-20 nm wide, 500-2000 nm in length) that are essentially different from CMFs in their synthesis, which leads to finer fibrils for CNFs. General surface chemistry of CNFs is, however, almost the same as the CNCs with the exception of minor groups related to the extraction method such as sulfate ester, carboxylic acid, etc. being present.

While it is known that the cellulose nanomaterial (CNM) adsorbs to the surface of the cement particle, providing high surface area per unit volume, and resulting in desired improvement in properties of cement such as reduction in hydration time, reduction of the viscosity by acting as a plasticizer, improving strength and resilience, and increases in hydration to cause beneficial changes to the cement paste composition, it is unknown how the surface chemistry affects these properties. Further, it is unknown why different suppliers' materials have different behaviors in cement. For example, it is known that while CNM works well in Type V sulfate resistant cement, it does not work well in Type I, II or III cements. As well, addition of supplementary cementitious materials (SCM) such as fly ash or additives such as plasticizers can affect the benefit that CNM provides to the cement paste composition.

Based on the foregoing, the present disclosure involves a series of surface modifications to elucidate the role of modified CNMs in cement paste compositions. The present disclosure has found that particular modifications of the surface of CNMs can provide additional advantages as compared to previous modifications. Particularly, the present disclosure uses additional surface functionalization of CNMs with groups such as silane, alumina, increased oxidation and addition of groups such as carboxyl to improve the interactions of CNMs with the cement paste composition, which can lead to improved binder bonding and improved dispersion with functionalization of CNMs with dispersants.

In some embodiments, the CNM used in the cement paste composition is ionized. For example, in one embodiment, the surface of the CMN can be anionized by adsorbing carboxymethylcellulose (CMC) to the surface of the CMN using methods described in El Awad et al., ACS Applied Polymer Materials 2020, 2, 3365-3377; El Award et al., Cellulose 2021, 28, 9149-91686; both of which are incorporated by reference to the extent they are consistent herewith.

In another embodiment, the surface of the CMN can be cationized. Suitable methods for cationization can include: 1) reaction of CNM with glycidylammonium chloride after deprotonation with KOH per Hasani et al., Soft Matter, 2008,4, 2238-2244, 2) adsorption of polyethyleneimine (PEI), a cationic polymer similar to methods described in Khandal et al., Physics of Fluids 31, 021207 (2019), followed by “setting” by reaction with glutaraldehyde, 3) treatment of CNM with tannic acid to prime it followed by reaction with polyethylenimine (PEI) in a method similar to Shrestha et al., Cellulose 2019, 26 (18), 9631-9643, where the amine is replaced with PEI. The above disclosed methods are incorporated by reference to the extent they are consistent herewith.

The reaction of CNM with tannic acid alone was also used to modify the CNM for use in the cement paste compositions of the present disclosure. Surprisingly, as shown in the working examples, tannic acid modification of the CNM led to some of the highest measured degrees of hydration as it increased 28-day hydration by more than 20%. As tannic acid is known as a retarder of cement (see Zhang et al., Cement and Concrete Composites, vol. 137, March 2023 (available online 5 Jan. 2023, doi.org/10.1016/j.cemconcomp.2023.104931)), this was completely unexpected.

In yet another embodiment, the CNM can be modified through non-covalent or covalent attachment of polyethylene glycol (PEGylation). The present disclosure used various PEGylation modifications, including: 1) priming CNM with tannic acid and then reaction with amine-functionalized PEG, 2) reacting the CNM with a silane-functional PEG in a similar manner to Tetraethylorthosilicate (TEOS) functionalization (details below), and 3) reacting PEG-amine with carbodiimide (CDI) as a coupling agent prior to reaction with CNM. This latter method was performed with both CNM and CNM with adsorbed CMC as the CDI coupling agent can work with carboxylic acids.

Additionally, the modified CNM used in the cement paste compositions of the present disclosure can be modified by silanization, particularly, by layering a thin molecular layer of silica on the surface of the CNM. This modification of the CNM surface can be through any of the following methods: 1) precipitation of silica by reaction with tetraethylorthosilicate (TEOS) in a similar manner described in Jo et al., Nanomaterials (Basel). 2021 Jun. 11; 11 (6): 1542. doi: 10.3390/nano1106154, and Sun et al., DOI: 10.1080/00222348.2018.1452490, both of which are incorporated by reference to the extent they are consistent herewith; 2) direct adsorption of colloidal silica, both cationic (e.g., Ludox CL) or anionic (e.g., Ludox HS), 3) priming CNM with tannic acid as described above and then reaction with aminopropyltriethoxysilane (APTES), and 4) direct sol-gel with APTES similarly to TEOS.

In a further embodiment, the CNM can be modified by reaction with alumina, similar to the silica modifications described above, for example, by sol-gel reaction with aluminum isopropoxide.

The modified cellulose nanomaterials can be present in the cement paste compositions in an amount of from about 0.005 volume % to about 1.5 volume %, with a particularly suitable amount of about 0.2 volume % modified CMMs.

When cellulose nanocrystals are used as the nanocellulose material, the length of the modified cellulose nanocrystals can be any suitable size known in the art. In some embodiments, the modified cellulose nanocrystals can have a length of from about 20 nm to about 600 nm, about 50 nm to about 500 nm, about 50 nm to about 400 nm, about 50 nm to about 350 nm, about 100 nm to about 300 nm, about 200 nm to about 300 nm; or about 200 nm, about 220 nm, about 250 nm, or about 300 nm, on average. In some embodiments, the length is less than 220 nm. Typically, the cross-sectional morphology of the nanocrystals is square. In some embodiments, however, the cross-sectional morphology can be rectangular. When rectangular, the height is used to refer to the larger value. The height of the cellulose nanocrystals can be at least about 2 nm and less than about 25 nm. The width of the cellulose nanocrystals can be at least about 2 nm and less than about 10 nm. Typically, the cellulose nanocrystals are about 3 nm to about 20 nm in height and about 3 nm to about 5 nm in width. The cellulose nanocrystals are commonly about 3-5 nm in width and about 3-10 nm in height, often about 3-10 nm in width and height. In one specific embodiment, the length of the cellulose nanocrystals is greater than about 150 nm and less than about 220 nm, and the diameter of the cellulose nanocrystals is greater than about 3 nm and less than about 15 nm, including greater than 3 nm and less than 10 nm.

To optimize the properties of the compositions, the modified cellulose nanomaterials are substantially evenly dispersed throughout the cement paste composition. The distribution can be enhanced by sonication, including ultrasonication or by high shear mixing, to further increase the dispersion of the modified CNMs throughout the cement paste composition.

The cement paste compositions of the present disclosure also include cement and can include various amounts of water, which result in improved cement compositions upon curing. To prepare the cement paste compositions, a Type V cement can be used. However, a wide variety of types of cement can be used to provide suitable and effective cement paste compositions with improved physical properties, as described herein. Other suitable types of cement include Portland cement, energetically modified cement made from pozzolanic minerals, and cement blends such as blends of blast furnace and cement, flyash and cement, pozzolan and cement, silica fume and cement, masonry cement, stucco cements, expansive cements, white blended cements, colored cements or “blended hydraulic cements”, very finely ground cements, Pozzolan-lime cements, slag-lime cements, supersulfated cements, calcium sulfoaluminate cements, natural cements, geopolymer cements, and green cements.

In some embodiments, specific examples of cement-based materials that can be used include aluminous cement, blast furnace cement, calcium aluminate cement, Type I Portland cement, Type IA Portland cement, Type II Portland cement, Type HA Portland cement, Type III Portland cement, Type IIIA, Type IV Portland cement, Type V Portland cement, hydraulic cement such as white cement, gray cement, blended hydraulic cement, Type IS-Portland blast-furnace slag cement, Type IP and Type P-Portland-pozzolan cement, Type S-slag cement, Type I (PMY pozzolan modified Portland cement, and Type I (SM)-slag modified Portland cement, Type GU-blended hydraulic cement, Type HE-high-early-strength cement, Type MS-moderate sulfate resistant cement, Type HS-high sulfate resistant cement, Type MH-moderate heat of hydration cement, Type LH-low heat of hydration cement, Type K expansive cement, Type O expansive cement, Type M expansive cement, Type S expansive cement, regulated set cement, very high early strength cement, high iron cement, oil-well cement, concrete fiber cement deposits, or a composite material including any one or more of the above listed cements. The different types of cement can be characterized by The American Society for Testing and Materials (ASTM) Specification C-150.

In some embodiments, the compositions include water. In other embodiments, the compositions do not include added water. For water-based cement pastes, a wide range of water-to-cement ratios can be effectively employed, ranging from about 0.3 to about 0.6, with a particularly suitable and effective amount of water-to-cement ratio of about 0.40.

In various embodiments, the composition does not contain a surfactant, a plasticizer, a dispersing agent, or a water reducing agent (other than the CNMs). In the compositions and methods described herein, the cement paste composition can be dry (e.g., without added water), or wet, or uncured, or cured. In further embodiments, the composition can include a surfactant, a plasticizer, and/or a dispersing agent.

In some embodiments, by adding CNCs to cement and water, the flexural strength of the composition upon curing and hardening can be increased by at least 10% compared to a corresponding composition that lacks the cellulose nanocrystals, for example, as determined by a ball-on-three-ball flexural strength analysis. Mechanical tests of the cured cement pastes described herein show an increase in the flexural strength of approximately 20% to 50% with only 0.2% volume of CNCs with respect to cement. In one embodiment, the flexural strength of the composition upon curing and hardening is increased by at least 20%. In another embodiment, the flexural strength of the composition upon curing and hardening is increased by at least 25%. In yet another embodiment, the flexural strength of the composition upon curing and hardening is increased by at least 30%. In a further embodiment, the flexural strength of the composition upon curing and hardening is increased by at least 40%. In a specific embodiment, the flexural strength of the composition upon curing and hardening is increased by at least about 50%. At any given volume % of CNCs, the flexural strength can be increased by sonication of the fresh cement paste to increase distribution and reduce agglomeration of the CNCs throughout the composition. In a preferred embodiment, the sonication is ultrasonication (often 15 kHz to 55 kHz, typically >20 kHz)).

The cement paste compositions can be used to provide compositions such as concrete, self-compacting concrete, mortar, or grout.

Cement-based material prepared from the cement paste compositions described herein can include other components or fillers as known by those skilled in the art, such as those used to form various types of concretes. For example, the cement-based material can optionally include aggregates, air-entraining agents, retarding agents, accelerating agents such as catalysts, plasticizers, corrosion inhibitors, alkali-silica reactivity reduction agents, bonding agents, colorants, and the like. “Aggregates” as used herein, unless otherwise stated, refer to granular materials such as sand, gravel, crushed stone or silica fume. Other examples of aggregate materials include recycled concrete, crushed slag, crushed iron ore, or expanded (i.e., heat-treated) clay, shale, or slate.

### EXAMPLE

In this Example, a series of surface modifications to elucidate the role of CNMs in cement paste compositions were conducted. Further, the effect of the modified CNMs on the hydration of the cement was measured using a furnace and isothermal calorimetry (IC) at 7-days and non-evaporable water after 28 days.

Type II Ordinary Portland Cement (OPC) was mixed with water at a water: binder ratio of 0.4 to form the cement paste composition used for analysis in all test samples. 0.2 volume % modified CNM was then dispersed into the composition samples. The composition was then cured for analysis. The results are categorized by CNM modification class, although multiple different chemical routes to similar surface chemistries were attempted to glean how general surface properties can affect behavior. Both CNC and CNF were used as CNMs, except for the pH studies. No supplementary cementing materials (SCMs), amendment or additive was used. Controls of pure OPC and unmodified CNM were also run. Two replicates were run for all samples.

### pH

Previous work has shown that the addition of extra KOH to a cement to increase alkalinity can have a dramatic improvement on the heat release of CNM added to cement. Separately, it is known that high pH can alter the structure of cellulose and convert it from cellulose I to cellulose II. It was suspected that the high pH of cement may also be affecting the structure of cellulose in the pore solutions. Thus, CNM (CNC only) was brought to pH of 8, 11, and 13 using KOH and then neutralized with HCL to pH 8 and isolated. Results were inconclusive, although there is likely no effect. pH 8 had an anomalous increase in hydration, but this is likely due to the small amount of KOH added that was not neutralized to the salt (i.e., the alkalinity effect).

### Anionization

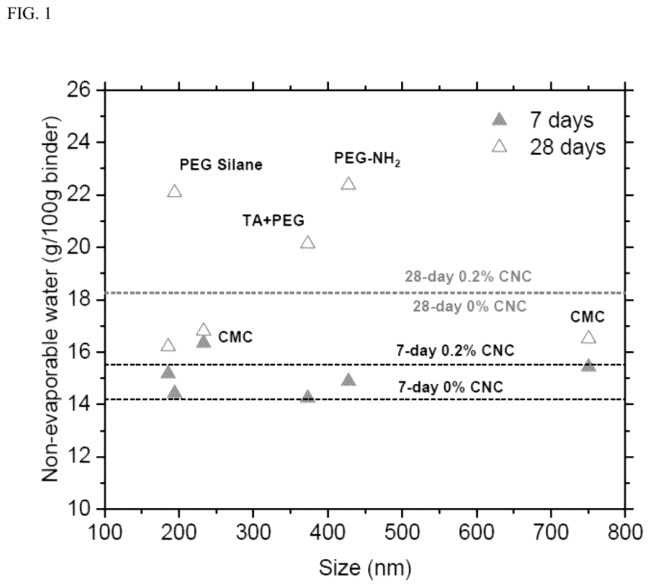

Previous work has shown that there is a difference in behavior between carboxylic acid functional CNM and sulfate ester functional CNM, especially in Type I/II cement. The effect of post-reaction oxidation was previously investigated to increase charge with marginal improvement. To further increase this charge was increased by adsorption of carboxymethylcellulose (CMC) using methods described herein. The addition of CMC and the resulting increase in charge accelerated early hydration, however, had marginal effects on 28-day hydration (see FIG. 1). Interestingly, CMC adsorbed materials increased 7-day hydration, whereas no other materials did so.

### Cationization

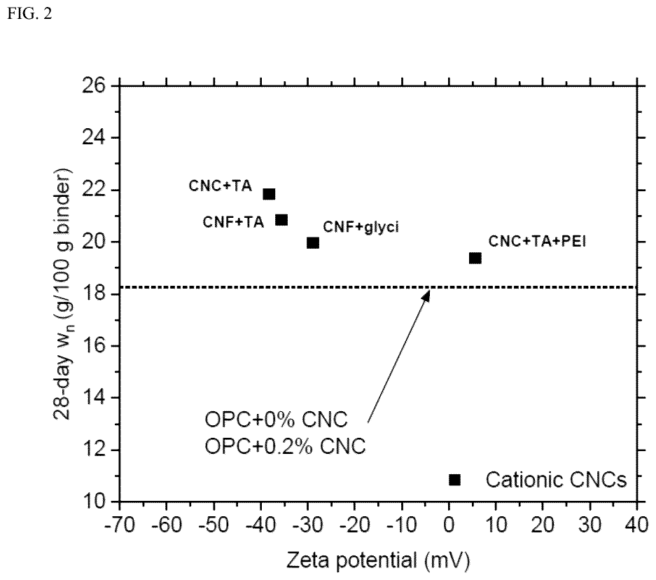

As increasing negative charge has little effect, cationization was instead attempted on CNM to make the surface less negative and even positive. This was accomplished using three methods: 1) reaction of CNM glycidylammonium chloride after deprotonation with KOH as described herein, 2) adsorption of polyethyleneimine (PEI), described herein, followed by “setting” by reaction with glutaraldehyde, 3) treatment of CNM with tannic acid to prime it followed by reaction with PEI in the methods described herein, where the amine is replaced with PEI. Results showed that these reactions increased 28-hydration by 5-11% over the unmodified control (see FIG. 2).

### Tannic Acid

As a control experiment, the “primed” CNM reacted only with tannic acid was also analyzed. Surprisingly, it had an even higher 28-day hydration than the cationized material and is close to some of the highest measured this Example as it increased 28-day hydration by more than 20% (See FIG. 2). Tannic acid is actually known as a retarder of cement, so this is completely surprising.

### PEGylation

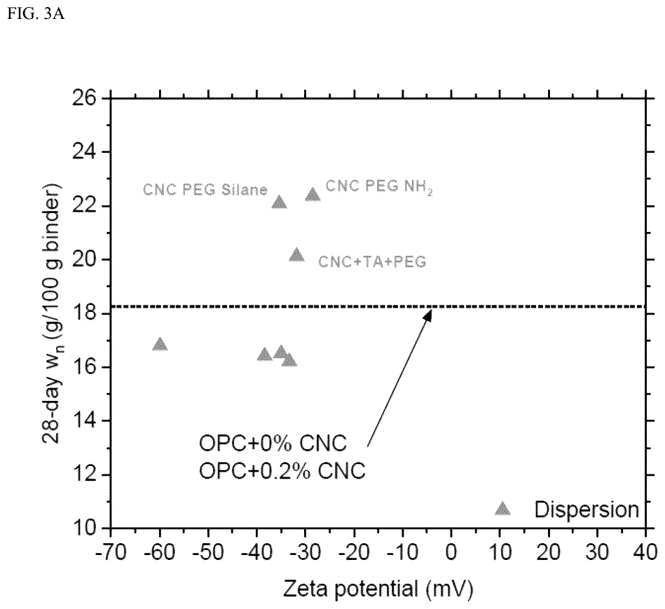

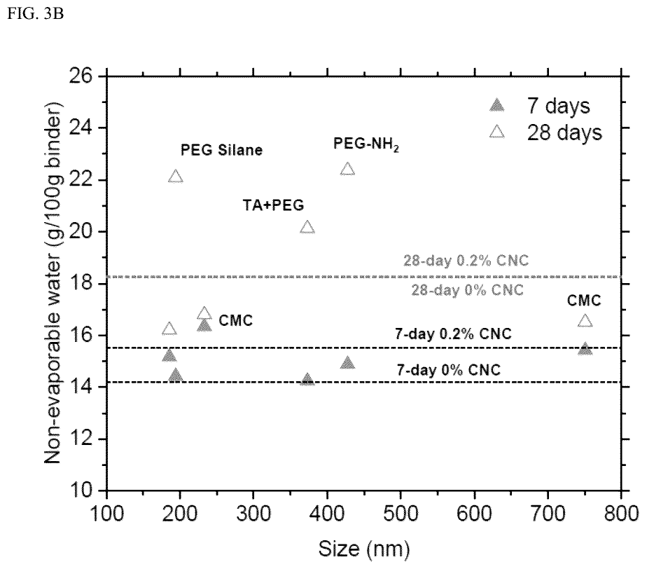

Based on prior work that showed that dispersion is key to improving CNM properties in cement and that steric stabilization, rather than electrostatic stabilization, is a superior method of achieving dispersion in complex media, PEGylation was analyzed as a modifier of the CNM surface. This was performed in three ways as described herein: 1) priming CNM with tannic acid and then reaction with amine-functionalized PEG similar to before, 2) reacting the CNM with a silane-functional PEG in a similar manner to TEOS functionalization, 3) reacting PEG-amine with carbodiimide as a coupling agent prior to reaction with CNM. This latter method was performed with both CNM and CNM with adsorbed CMC as the CDI coupling agent can work with carboxylic acids. Results showed that some PEGylation reactions such as PEG-silane of method 2 and PEGamine-CDI of method 3 were highly effective in increasing 28-day hydration with a ˜20-25% increase (see FIGS. 3A & 3B), whereas tannic acid priming of method 1 was moderately beneficial with a 10-15% increase (see FIGS. 3A & 3B).

### Silanization

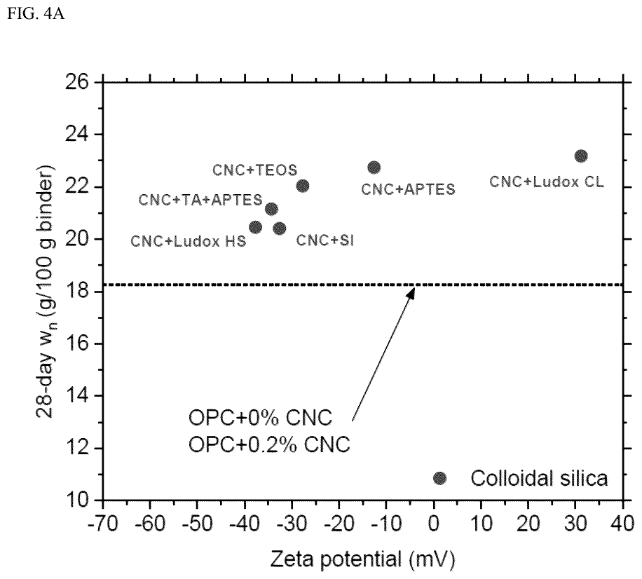

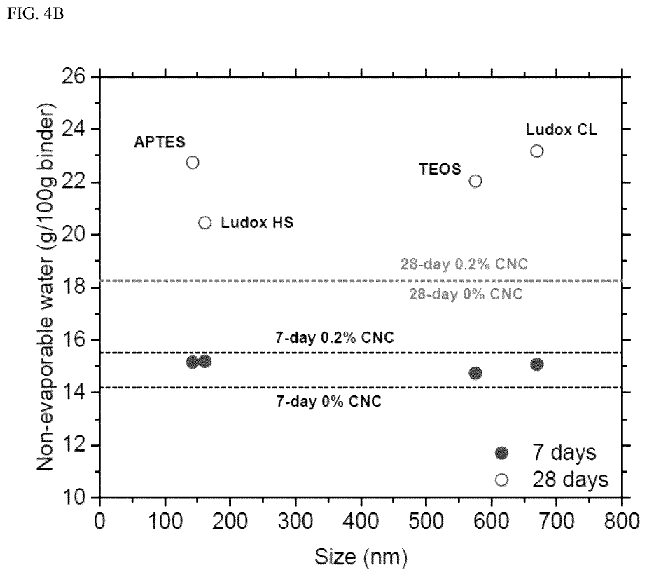

Addition of silica to OPC in the form of fly ash, clay, or silica fume has a beneficial effect on the strength, durability, and hydration of cement. It is also suspected that certain types of fly ash have deleterious effects on CNM in cement. Thus, in an attempt to improve the interaction of CNM with cement, a thin molecular layer of silica was put on the surface of the CNM. This was attempted using four methods as described herein: 1) precipitation of silica by reaction with tetraethylorthosilicate (TEOS), 2) direct adsorption of colloidal silica, both cationic (Ludox CL) or anionic (Ludox HS), 3) priming CNM with tannic acid as before and then reaction with aminopropyltriethoxysilane (APTES), and 4) direct sol-gel with APTES similarly to TEOS. This last method is a control for the tannic acid route and the methods of 3 and 4 were hoped to give both a silica surface and a more cationic surface for two functionalities on a surface. Results showed that all silica surface modification increased 28-day hydration over the unmodified CNC control by 10-30% (see FIGS. 4A & 4B). Particularly, as shown in FIGS. 4A & 4B, the sol-gel CNC-APTES of method 4 and CNC+cationic Ludox CL were the highest hydration.

### SUMMARY

Overall, results showed that pH changes likely had no effect. Anionization had no effect on 28-day hydration. However, it could speed the reaction as it was the only modification to increase 7-day heat release. Cationization had a moderate effect on 28-day hydration. PEGylation and silanization had large effects on 28-day hydration. Tannic Acid priming also had a large effect on 28-day hydration.

What is claimed is:

1. A cement paste composition comprising cement, water and from about 0.005 volume % to about 1.5 volume % modified cellulose nanomaterial.

2. The cement paste composition of claim 1 comprising about 0.2 volume % modified cellulose nanomaterial.

3. The cement paste composition of claim 1, wherein the modified cellulose nanomaterial is an anionized cellulose nanomaterial.

4. The cement paste composition of claim 3, wherein the anionization of the modified cellulose nanomaterial is by adsorption of carboxymethylcellulose on the surface of the cellulose nanomaterial.

5. The cement paste composition of claim 1, wherein the modified cellulose nanomaterial is a cationized cellulose nanomaterial.

6. The cement paste composition of claim 5, wherein the cationization of the modified cellulose nanomaterial is by adsorption of polyethyleneimine (PEI) on the surface of the cellulose nanomaterial.

7. The cement paste composition of claim 1, wherein the modified cellulose nanomaterial comprises at least one layer of silica on the outer surface of the nanomaterial.

8. The cement paste composition of claim 7, wherein the modified cellulose nanomaterial has been primed with tannic acid.

9. The cement paste composition of claim 1, wherein the modified cellulose nanomaterial is a PEGylated cellulose nanomaterial.

10. The cement paste composition of claim 9, wherein the PEGylated cellulose nanomaterial comprises at least one of an amine-functionalized PEG and a silane-functionalized PEG.

11. The cement paste composition of claim 9, wherein the modified cellulose nanomaterial has been primed with tannic acid.

12. The cement paste composition of claim 1, wherein the modified cellulose nanomaterial is a modified cellulose nanocrystal having a length of from about 100 nm to about 300 nm.

13. The cement paste composition of claim 12, wherein the diameter of the modified cellulose nanocrystals is from about 3 nm to about 15 nm.

14. The cement paste composition of claim 1, wherein the length of the modified cellulose nanocrystals is less than 220 nm and the diameter of the cellulose nanocrystals is less than 10 nm.

15. The cement paste composition of claim 1 having an increased degree of hydration and cumulative heat evolution in comparison to cement paste composition without the modified cellulose nanomaterials, thereby resulting in a higher total cure of the cement paste composition upon curing.
